(19) United States
(12) Patent Application Publication
(10) Pub. No.: US 2012/0032033 A1
(43) Pub. Date: Feb. 9, 2012

(54) Wing piercing airplane

(75) Inventor: Jason Everett Cole, Westland, MI (US)

(73) Assignee: Jason Everett Cole, Westland, MI (US)

(21) Appl. No.: 13/164,056

(22) Filed: Jun. 20, 2011

Related U.S. Application Data
(60) Provisional application No. 61/370,373, filed on Aug. 3, 2010.

(51) Int. Cl. B64C 3/14; B64C 5/06; B64C 9/00

(52) U.S. Cl. 244/45 A; 244/35 R

(57) ABSTRACT

My invention is a wing piercing airplane design based on the Catamaran (or trimaran) boat design. The concept behind the wind piercing airplane is a airfoil that consist of forward pointed triangular shaped wing on the left & right side of the fuselage, triangular shaped forward pointed vertical fins, triangular shaped forward pointed horizontal tail, triangular forward pointed wingtips to pierce the oncoming air like a Catamaran boat pierce the water as it travels forward. Essentially applying water wave piercing physics to aeronautic flight theory. The objective of the new airfoil design is to exhibit wind piercing effects in the air for reduce drag for greater fuel efficiency, lower radar cross section when radar beam hits it head on for stealth military application, flight efficiency at both low subsonic and high supersonic speed in this same fix wing plane without the need for a swing wing geometry configuration. All airfoils from small propeller airplanes to supersonic jet fighters can have this same type of wind piercing fix wing airfoil without the need for a swing wing geometry configuration. This airfoil will replace straight wing aircraft and swept wing aircraft due to that the fact that this wing piercing airfoil is flight efficient at low speeds like a straight wing airplane and flight efficient at high speeds like a swept wing airplane.

### CROSS-REFERENCE TO RELATED APPLICATIONS

This applications claims priority benefit of provisional patent application No. 61/370373, filed 3 Aug. 2010, entitled “Wing piercing airplane”

### FIELD OF THE INVENTION

The invention relates to swing wing and straight wing aircraft configurations. More particularly, the invention provides a novel wing piercing airfoil that embodies the benefits of a swing wing and straight wing airfoil design in a fix wing design without the need for swing wing geometry configuration

### BACKGROUND OF THE INVENTION

The Background for this invention is aeronautics concerning straight wing, swept wing airplane flight performance and there limitations in dealing with drag, flight chararistics and efficiency at various flight regimes.

A typical aircraft needs variable swing geometry wings to be flight efficient at both low and high speed. Some planes have to be straight wings for great flight stability at low speed while other planes requires swept wings for higher flight speeds. General avaiation consist primarily of swept wings and straight, wing airplanes wing aircraft and each has it's advantages and disadvantages. The novel approach of my wing pericing airplane invention takes the best modes of straight wings, and swept and combine them into one efficient airfoil.

### BRIEF SUMMARY OF THE INVENTION

In a first aspect, the present invention overcomes the various issues or drawbacks of conventional fixedstraight wing or fixed-swept wing aircraft through the use a fix-winged triangular shaped airfoil configuration. General aviation consist primarily of two aircraft types: straight wings and swept wings. My “Wing piercing airplane” invention Introduces a third type of general airfoil that will have the best of both swept and straight wing properties. The “wing piercing airplane” is a aircraft consisting of forward pointed wings, wingtips, vertical fin, hortizonal tip for the aim of reducing drag on the aircraft as the aircraft flies into oncoming air. Essentially applying water wave piercing boat physics to aeronautic flight theory. Just as a catamaran(or triamaran) thin hull pierce the water for greater performance efficiency, the triangular forward pointed wings, fin, tail, wingtips pierce the oncoming air for reduced drag and great fuel and flight efficiency. This forward pointed wing piercing design reduces drag and it's efficient at low speed like a straight wing plane and this triangular fix wing plane also makes the plane efficient at high speed like swept wing aircraft. In which for this fix wing, wing piercing design it is fuel efficient and flight efficient at both low and high speed with the need for a swing wing geometry.

### DRAWING DESCRIPTION

FIG. 1: is a perspective view of the invention 10.

FIG. 2: is a side view of the invention 10.

FIG. 3: is a top view of the invention 10.

### DESCRIPTION LIST

10: is the overall invention.

12: is the forward pointed triangular wing.

14: is the front v shape slat

16: is the side flap aileron.

18: is the rear flap.

20: is the horizontal forward pointed triangular tail stabilizer.

22: is the vertical forward pointed triangular fin stabilizer.

24: is the forward pointed triangular canard.

26: is the fuselage & body of aircraft.

28: is the forward pointed wing tip.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides an aircraft. An aircraft may comprise a fuselage, first and second wings, a plurality of ailerons, and a plurality of actuators. The first and second wings may be mounted to the fuselage. A plurality of ailerons may be mounted around the perimeters of the first and the second wings. A plurality of actuators may be used to actuate the ailerons.

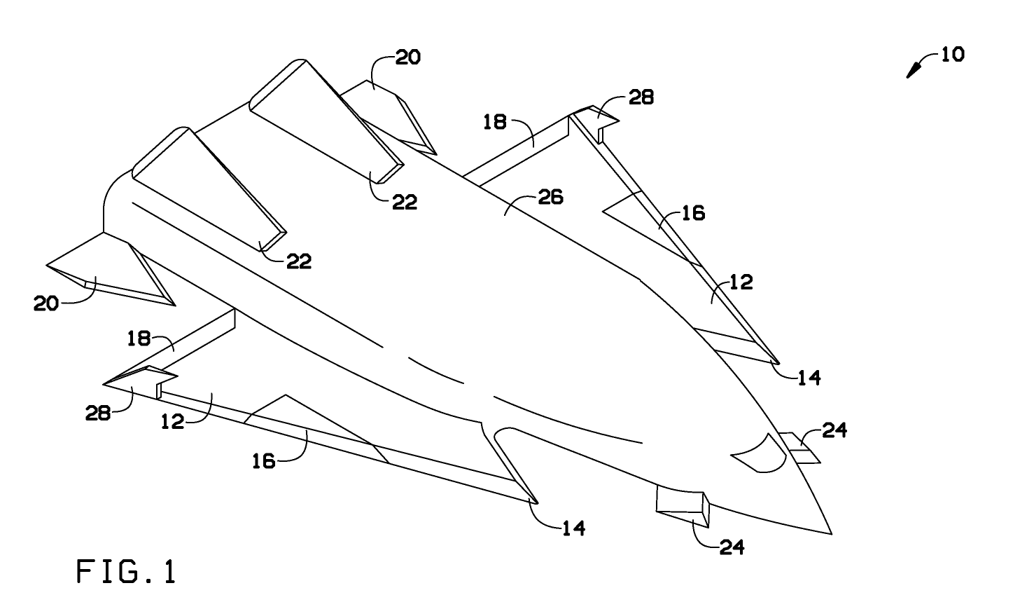

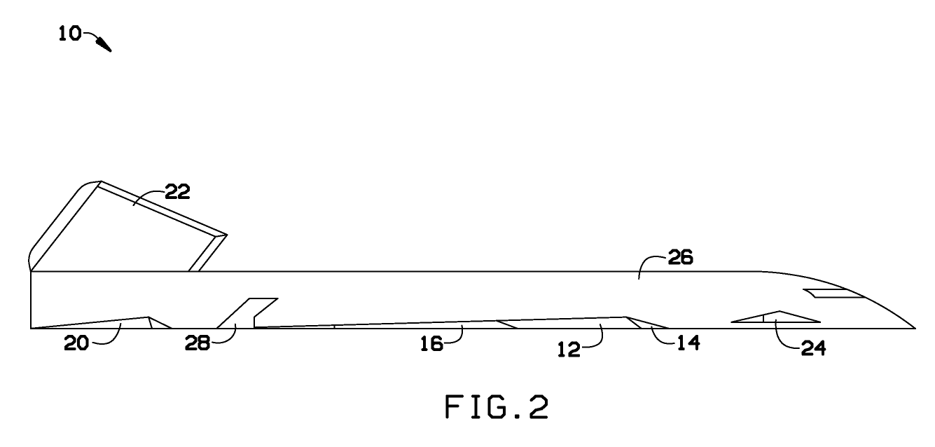

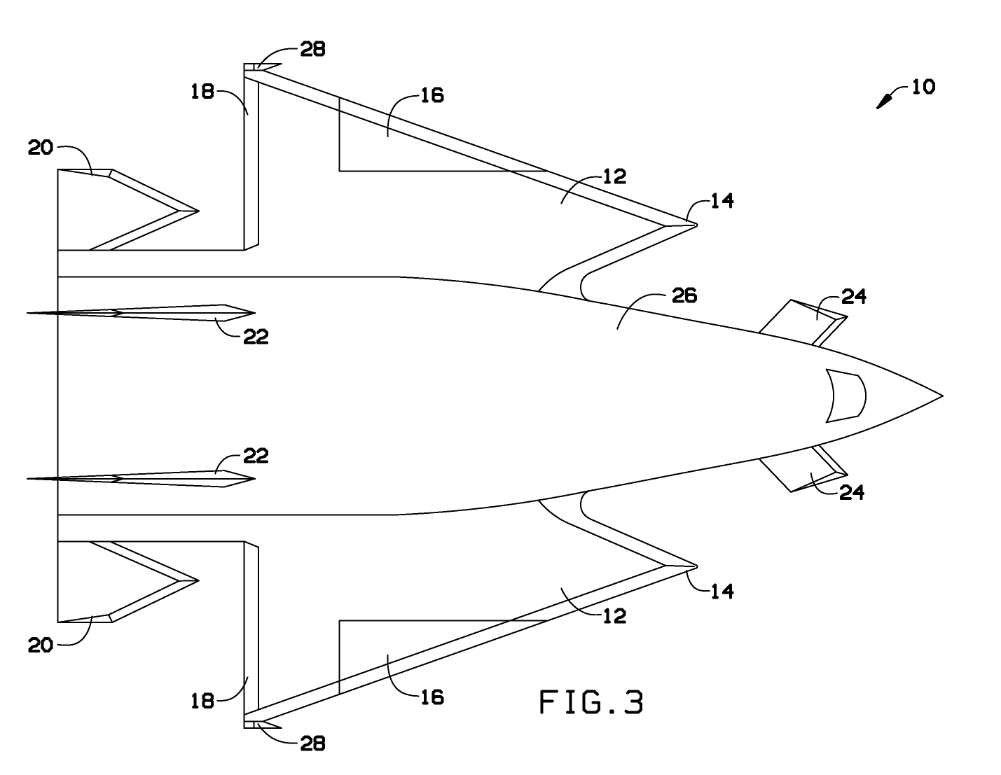

As shown in FIGS. 1-3, in exemplary embodiments of the present invention, the triangular shaped wings attached to either side of the fuselage may be made in one piece. The aft part of the wings may be like the base of a triangle. The front may be V shaped, for example, to contour the pointed end of the wing that pierces the air.

In an exemplary embodiment of the present invention, the front part of the triangular wing has a V shape slat The outer edge of the wing may have a side flap that goes along the outer side of the triangle shaped wing.

In an exemplary embodiment of the present invention, The aft part of the triangular wing has a rear flap

In an exemplary embodiment of the present invention, ailerons that are mounted on the outer perimeters of the triangular shaped wing may flap up and down for added roll control and stability during flight. The front part of the wings may extend forward and pierce the air where the entire wing may form a triangle.

Another exemplary embodiment of the present invention, the horizontal tail is triangular were the front pointed part face the oncoming air

An exemplary embodiment of the present invention may have a vertical fin. The fin may be triangular in shape. The front point of the vertical fin may be facing the oncoming air to pierce it and reduce drag, thus enabling the fuselage to be wider. The airplane may be more stable in flight when compared to a traditional V shaped swept wing aircraft. An exemplary embodiment of the present invention may have a short take off speed and still be efficient at both low subsonic and high supersonic speed in the same fixed wing plane.

An exemplary embodiment of the present invention, the carnard is triangular were the front point part face the oncoming air

An exemplary embodiment of the present invention, have fuselage

An exemplary embodiment of the present invention, the wingtip is triangular were the front point part face the oncoming air

An exemplary embodiment of the present invention may be used in all airplanes such as passenger jets, private jets, personal airplanes, bombers, jet fighters, cargo planes, helicopters, or aircraft toys, for example.

In an exemplary embodiment of the present invention, the pointed wings may pierce the air as the plane travels forward like a Catamaran boat, with two lower parts in the water piercing the water as it travels forward. In much the same way, a swept wing airplane may be designed based on a V shaped boat hull to have the air swept around the wing rather than hitting the air straight on.

In an exemplary embodiment of the present invention, the two pointed triangle wings on the left or right side of the fuselage may be parallel. The triangle shaped wing may be widest at the rear aft and as the wing extends forward to form the triangle.

An exemplary embodiment of the present invention may be used in a new helicopter design where the blades may pierce the air rather than sweep back like sea lynx helicopters.

It should be understood, of course, that the foregoing relates to exemplary embodiments of the invention and that modifications may be made without departing from the spirit and scope of the invention as set forth in the following claims.

I claim:

1. An aircraft comprising:
a fuselage;
a first and second one piece triangular wing mounted to the fuselage;

2. The aircraft of claim 1, a plurality of ailerons mounted around the perimeters of the first and the second triangular shaped wing;
a plurality of actuators actuating the ailerons;

3. The aircraft of claim 1, a plurality of side flaps on the outer edge of the triangular wing

4. The aircraft of claim 1, a plurality of V shape slats on the pointed end of the pointed triangular wing

5. The aircraft of claim 1, a plurality of triangular pointed vertical fins;

6. The aircraft of claim 1, a first and second vertical triangular pointed wingtip on the outer edge of each wing;

7. The aircraft of claim 1, a first and second one piece triangular pointed tail mounted on either side of the aft of the aircraft

8. The aircraft of claim 1, and a first and second one piece triangular shaped canard mounted to the front part of the aircraft.
